(19) United States
(12) Patent Application Publication
(10) Pub. No.: US 2021/0209934 A1
(43) Pub. Date: Jul. 8, 2021

(54) SEX TOYS SYSTEM AND METHOD

(71) Applicants: ZEEV SILES, HAIFA (IL); DAVID METSER, MODIIN (IL)

(72) Inventors: ZEEV SILES, HAIFA (IL); DAVID METSER, MODIIN (IL)

(21) Appl. No.: 16/950,931

(22) Filed: Nov. 18, 2020

(30) Foreign Application Priority Data
Jan. 2, 2020 (IL) 271822

(51) Int. Cl. G08C 17/02; H04W 4/80; G06F 3/16; H04N 21/44; A61H 19/00; G06F 9/451

(52) U.S. Cl. CPC G08C 17/02; H04W 4/80; G06F 3/167; H04N 21/44; A61H 19/44; G08C 2201/31; G06F 9/452; A61H 2201/5012; A61H 2201/5097; A61H 2201/5043; A61H 2201/5048; A61H 19/50

(57) ABSTRACT

A sex toys system including an application program executed on a user terminal, the application program being adapted to (a) display a video presentation, and (b) propagate commands scheduled with the video presentation, to sex toys, over a short-range wireless communication channel.

### TECHNICAL FIELD

The invention relates to the field of remote sex entertainment.

### BACKGROUND

The term “sex toy” is defined by Wikipedia as “an object or device that is primarily used to facilitate human sexual pleasure, such as a dildo or vibrator. Many popular sex toys are designed to resemble human genitals, and may be vibrating or non-vibrating. The term sex toy can also include BDSM apparatus and sex furniture such as slings.” (From Wikipedia) In this patent application, the term sex toy includes any device connected directly or indirectly to a sex act, including lights for providing a romantic atmosphere and the like.

The term “remote sex toy” refers herein to a sex toy operated by commands transmitted over a wide area network (such as the Internet) by a remote user. For example, a first user controls the operation of a sex toy of a second user over the internet.

Presently, remote sex toys are well known. For example, https://www.youtube.com/watch?v=w3oOm8Qhdm4 presents an operation of such devices, and https://www.lovense.com/public/store presents products in this area.

FIG. 1 schematically illustrates data flow in a sex toys system, according to the prior art.

A first user uses an application program (not shown) executed on a first smartphone 11 to activate a sex toy 15 at the side of a second user which executes a corresponding application program on a second smartphone 12.

The communication between the application programs is carried out via a wide area network 13 such as the internet.

At the second user side, the smartphone 12 communicates with the sex toys 15 via a short-range wireless communication, such as Bluetooth, and instructs the sex toys 15 to change their operation mode, speed (e.g., vibration), and so on.

It should be noted that as of today the application software does not include video display but only buttons, check boxes, menus etc. Of course, the users may see each other via a video chat application, but there is no embedded means in dedicated application programs for displaying a video.

The use of remote sex toys has become popular in the recent years. This indicates that there is a continuing need to enhance sexual experience through sex toys.

### SUMMARY

The invention, in embodiments thereof, provides means for increasing the sex experience using remote sex toys.

In one aspect, the invention is directed to a sex toys system, comprising: an application program executed on a user terminal, the application program being adapted to (a) display a video presentation, and (b) propagate commands scheduled with the video presentation, to sex toys, over a short-range wireless communication channel.

According to one embodiment of the invention, the video presentation and commands are stored at the user terminal.

According to another embodiment of the invention, the video presentation and commands are transmitted from a remote site to the user terminal over a wide area network.

According to one embodiment of the invention, the remote site is a web site.

According to one embodiment of the invention, the user terminal is a smartphone.

According to another embodiment of the invention, the user terminal is a desktop computer.

According to one embodiment of the invention, the application program is adapted to display a video presentation sent from a remote user terminal, while video photographing a user thereof and sending a video presentation thereof to the remote user terminal.

According to one embodiment of the invention, a video file of the video presentation bears the scheduled commands to the sex toy(s).

According to another embodiment of the invention, the commands are stored in a file including a schedule of operation of each of the commands.

According to one embodiment of the invention, the application program is adapted to receive input commands for operating a sex toy of a remote user by a voice user interface.

In another aspect, the invention is directed to a method for operating a sex toy, the method comprising the step of:
(a) providing a user terminal for executing an application program adapted to display a video presentation and to propagate commands to the sex toy over a short-range wireless communication channel; and
(b) while displaying the video presentation by the user terminal, sending commands scheduled with the video presentation, to the sex toys, via a short-range wireless communication channel.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

### BRIEF DESCRIPTION OF DRAWINGS

Embodiments, features, and aspects of the invention are described herein in conjunction with the following drawings:

FIG. 1 schematically illustrates data flow in a sex toys system, according to the prior art.

FIG. 2 schematically illustrates data flow in a sex toys system, according to one embodiment of the invention.

FIG. 3 schematically illustrates a user interface of a sex toys system, according to one embodiment of the invention.

FIG. 4 schematically illustrates data flow in a sex toys system, according to a further embodiment of the invention.

FIG. 5 schematically illustrates data flow in a sex toys system, according to a yet further embodiment of the invention.

FIG. 6 is a block diagram schematically illustrating data flow in a sex toys system, according to one embodiment of the invention.

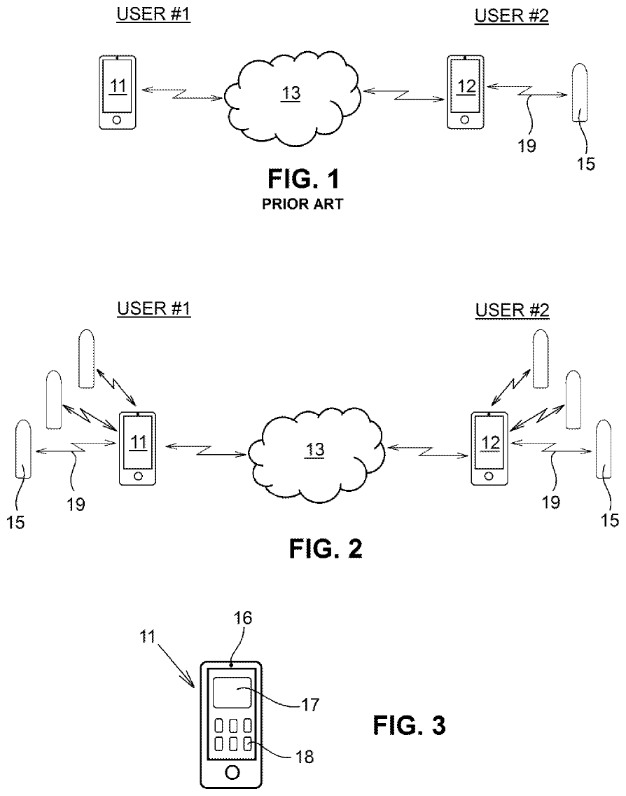

It should be understood that the drawings are not necessarily drawn to scale.

### DETAILED DESCRIPTION

The invention will be understood from the following detailed description of embodiments thereof which are meant to be descriptive and not limiting. For the sake of brevity, some well-known features, methods, systems, procedures, components, circuits, and so on, are not described in detail.

FIG. 2 schematically illustrates data flow in a sex toys system, according to one embodiment of the invention.

FIG. 3 schematically illustrates a user interface of a sex toys system, according to one embodiment of the invention.

At each side (of a user the) the application program (not illustrated) uses the camera 16 of his smartphone for photographing live video of the user, and transmitting it to the smartphone of the remote user. Thus, the user interface of each user includes a video presentation 17 of the video photographing of the remote user. In addition, the user interface also includes operation buttons 18, by which the user may activate and deactivate a sex toy 15 of the remote user, change its operation mode, increase and decrease its vibration rate and/or velocity, etc.

Commands for changing the mode of operation (on, off, velocity, vibration rate, etc.) of the sex toys of the remote user are transmitted also via the communication channels.

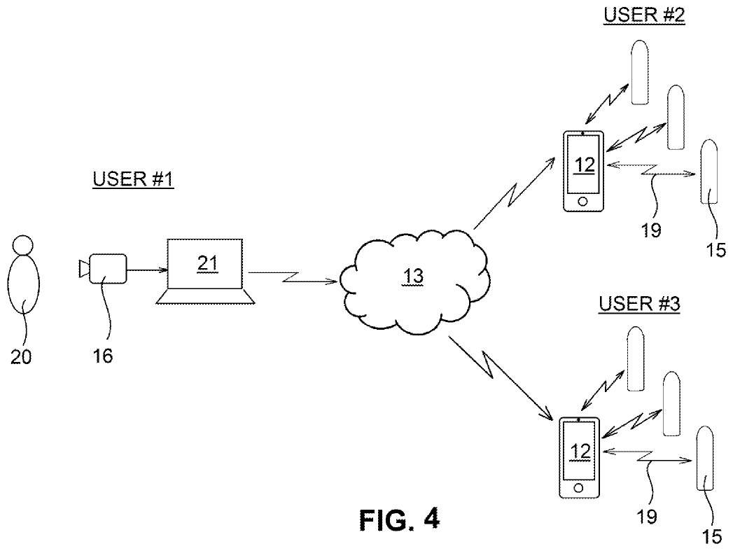

FIG. 4 schematically illustrates data flow in a sex toys system, according to a further embodiment of the invention.

At the side of the first user is installed a camera 16, which transmits via computer 21 live video including commands to sex toys to a plurality of users, each having his own sec toys.

This arrangement can be carried out using a web site (not shown). Each of the users connects to the web site via his smartphone or computer (not shown), and watches the show while his sex toys are controlled by signals sent from the first user.

The commands to the sex toys may be sent by the performer (user 20), by a human assistant (not illustrated), by voice commands or by a device or application program in which the operation of the remote sex toys can be changed (e.g., changing the vibration rate of a vibrator).

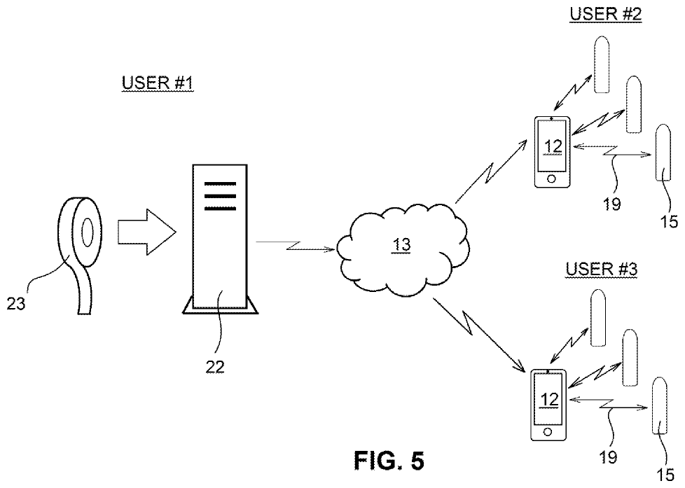

FIG. 5 schematically illustrates data flow in a sex toys system, according to a yet further embodiment of the invention.

A web server 22, which provides web services, runs a web site in which its users can watch a sex movie 23 while the sex toys 15 of each user are provided with commands to his sex toys, synchronized with the movie.

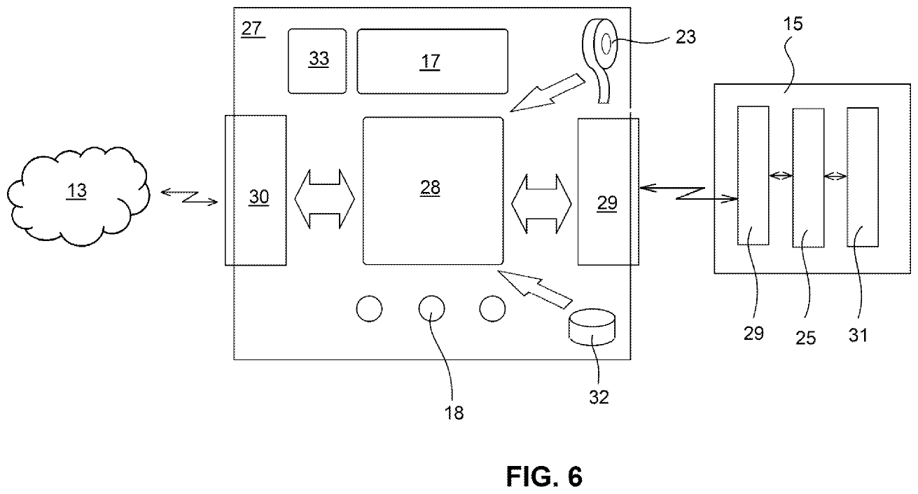

FIG. 6 is a block diagram schematically illustrating data flow in a sex toys system, according to one embodiment of the invention.

The “heart” of the system is a user terminal 27, which interacts with one or more remote sex toys 15. The user terminal may be any computerized facility, such as a desktop computer, a smartphone, etc.

The user terminal 27 comprises a display 17 for displaying a sex movie. While displaying the sex movie, the user terminal sends operation commands to the sex toys over a short-range wireless communication channel, such as Bluetooth. The operation schedule of the sex toys corresponds to the contents on the movies, such as increasing or decreasing a vibration rate and intensity of a sex toy 15 at a certain moment of the movie.

The sex movie can reside on the user terminal 27 (e.g., a video file), or can be transmitted from a remote site to the user terminal over a wide area network such as the internet, while being played on the user terminal (“streaming”).

In addition, the video signal of the movie can bear scheduled commands to the sex toys, which are propagated to the sex toys 15 at the scheduled times. Alternatively, a scheduled commands file can be used. The scheduled commands file can reside on the user terminal or can be transmitted to the user terminal from the remote location along with the video signal.

### Sex Toys Commands File

When displaying a recorded movie (in contrast to a live video), a schedule of operating the remote sex toys have to be set. For example, at a certain time point a certain sex toy has to be activated, at another time point a certain sex toy has to be deactivated, its velocity has to be increased (for example by 10%), etc. This time schedule has to be recorded somewhere and transmitted to the remote user terminals.

One way to transfer a list of commands to a remote user terminal is through a commands file. A command in such a file may contain information such as the sex toy type (vibrator, desire eggs, light, padlock, shocker, steps tracker band with heart rate tracker, etc.), operation type (e.g., turn on, turn off, vibrate, cease gradually, etc.), operation intensity, duration, the time from the beginning of the movie to activate this operation, etc. The application program on a user terminal (smartphone, computer, etc.) at the remote user side gets the commands file, and while playing the corresponding movie, at the scheduled time of a command it sends the operation instruction of this command to the corresponding sex toy via short-range transmission such as Bluetooth.

Another way to transfer commands to a user terminal at the remote side is through a sound file, or sound part of a video file. Since the human ear cannot hear all the frequencies, some bits of an audio file can be used in an audio file to transfer commands. Assuming at any given moment on a video file there are 5 bits usable as a command for sex toys, then 2 bits (for example) can be used to identify the sex toy type (vibrator, lust eggs, light, etc.), and the other bits can be used to set the intensity operation. The location on the sound file determines the time the operation will take place.

In the figures and/or description herein, the following reference numerals (Reference Signs List) have been mentioned:
numeral 11 denotes s smartphone of a first user;
numeral 12 denotes s smartphone of a second user (a remote user);
numeral 13 denotes a wide area network, such as the internet, telephony network, etc.;
numeral 14 denotes a video source;
numeral 15 denotes a sex toy;
numeral 16 denotes a camera;
numeral 17 denotes a display;
numeral 18 denotes operation buttons;
numeral 19 denotes a short-range wireless communication, such as Bluetooth;
numeral 20 denotes a user;
numeral 21 denotes a computer;
numeral 22 denotes a web server;
numeral 23 denotes a video file;
numeral 24 denotes a communication module;
numeral 25 denotes a controller;
numeral 26 denotes a hardware mechanism;
numeral 27 denotes a user terminal;
numeral 28 denotes an application program;
numeral 29 denotes a short-range communication module;
numeral 30 denotes a long distance communication module;
numeral 31 denotes a sex toy mechanical module;
numeral 32 denotes a scheduled commands file for sex toy(s); and
numeral 33 denotes a speaker.

In the text herein, the following terms have been mentioned:

Wide Area Network (WAN) Wide Area Network refers to a large network that uses high-speed lines, switches, and routers. It connects to LANs at router point.

Local Area Network (LAN) is an interconnected system of computers and peripherals, LAN users share data stored on hard disks and can share printers connected to the network. A general term for large networks using high speed lines, switches, and routers. It connects to LANs at router point.

“A Web server is a program that uses HTTP (Hypertext Transfer Protocol) to serve the files that form Web pages to users, in response to their requests, which are forwarded by their computers' HTTP clients. Dedicated computers and appliances may be referred to as Web servers as well.” (From whatis.com)

The term Bluetooth refers in the art to a wireless technology standard used for exchanging data between devices over short-ranges using short-wavelength UHF radio waves. Bluetooth is managed by the Bluetooth Special Interest Group (SIG).

The term “short-range wireless communication channel” refers herein to a wireless communication channel over a distance of at least 5 meters. Examples of short-range communication protocols are Bluetooth, IEEE 802.11, ultra-wideband (UWB), shared wireless access protocol (SWAP), digital enhanced cordless telecommunications (DECT), GSM, UMTS, CDMA, WCDMA, IRDA (infrared data association) protocols, CDMA2000, time-division CDMA (TD-CDMA), HiperLAN2, HomeRF, or wide band frequency hopping (WBFH).

The term “Voice User Interface” (VUI) is the term used to describe the interaction with a computerized mechanism through a voice/speech platform in order to initiate an automated service or process.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A sex toys system, comprising:
an application program executed on a user terminal, said application program being adapted to (a) display a video presentation, and (b) propagate commands scheduled with said video presentation, to sex toys, over a short-range wireless communication channel.

2. A system according to claim 1, wherein said video presentation and commands are stored at said user terminal.

3. A system according to claim 1, wherein said video presentation and commands are transmitted from a remote site to said user terminal over a wide area network.

4. A system according to claim 3, wherein said remote site is a web site.

5. A system according to claim 1, wherein said user terminal is a smartphone.

6. A system according to claim 1, wherein said user terminal is a desktop computer.

7. A system according to claim 1, wherein said application program is adapted to display a video presentation sent from a remote user terminal, while video photographing a user thereof and sending a video presentation thereof to said remote user terminal.

8. A system according to claim 1, wherein a video file of said video presentation bears said scheduled commands.

9. A system according to claim 1, wherein said commands are stored in a file including a schedule of operation of each of said commands.

10. A system according to claim 1, wherein said application program is adapted to receive input commands for operating a sex toy of a remote user by a voice user interface.

11. A method for operating a sex toy, the method comprising the step of:
(a) providing a user terminal for executing an application program adapted to display a video presentation and to propagate commands to a sex toy over a short-range wireless communication channel; and
(b) while displaying said video presentation by said user terminal, sending commands scheduled with said video presentation, to said toy, via a short-range wireless communication channel.
